(19) United States
(12) Patent Application Publication
(10) Pub. No.: US 2017/0202356 A1
(43) Pub. Date: Jul. 20, 2017

(54) SUPPORT FOR HOLDING POPCORN AND SIMILAR CONTAINERS

(71) Applicant: Jose Maria Penas Varo, Ames (A Coruna) (ES)

(72) Inventor: Jose Maria Penas Varo, Ames (A Coruna) (ES)

(21) Appl. No.: 15/245,319

(22) Filed: Aug. 24, 2016

(30) Foreign Application Priority Data
Jan. 14, 2016 (ES) U201600016

(51) Int. Cl. A47C 7/62; A47C 1/12; F16B 45/00; F16M 13/02; F16B 2/10; F16B 2/12

(52) U.S. Cl. CPC A47C 7/62; F16B 2/10; F16B 2/12; F16B 45/00; F16M 13/022; A47C 1/12

(57) ABSTRACT

A support for holding popcorn containers at the end of a movie theater armrest. A support platform is provided for the base of a container of popcorn. The support platform extends from, and is supported by, one edge of an existing cup holder hoop. A vertical mast with a hooking element attaches to the cup holder hoop.

### OBJECT OF THE INVENTION

The present invention relates to a holder for popcorn containers, intended specifically for use in cinemas, a complement to the classic armrest hoop intended for placing a cup or bottle with any type of drink.

The object of the invention is to provide the market and the general public, a support that can relate to the drink holding hoop, and can accommodate popcorn containers of different sizes in a completely efficient and safe manner.

### ANTECEDENTS OF THE INVENTION

In the practical field of application of the invention, such as cinemas, theaters and the like, the seats or chairs usually provide a kind of hoop to hold a drink in a cup or bottle in the armrest, and thus leave the seat occupant's hands free; logically the drink is available to the user so that he can have it whenever he wants.

While this device is practical and very comfortable for users, however, it is common that the drinks are accompanied by food, usually packages of popcorn of dimensions that are significantly greater than those of the drinks. So although the hoop may be idle, that is, even if the user intends not to consume a drink simultaneously with the consumption of popcorn and the like, said device does not allow housing within it such packaging, so the users must keep it in their hands throughout the movie, or leave it on the floor with the risk of tipping it over with their feet, which happens quite frequently.

### DESCRIPTION OF THE INVENTION

The advocated device solves the problem outlined above in a fully satisfactory manner, based on a simple but highly effective structure.

For this purpose, it is designed to interact with the classical hoop at the end of the armrests of seats for theaters and the like. The support of the invention presents the particularity that constitutes a fastener for a container of popcorn, regardless of its size and configuration, being equally suitable for quadrangular contours and inverted conical packaging.

More specifically, the support is constituted from a small platform as a support and seating for the base of the popcorn container, so that from one edge of said support platform emerges a mast, whose upper end is provided with means for linking the armrest support hoop, also having means for securing the perimeter of the package which rests on the said base, whatever its size and configuration.

The mast is associated with said hoop through a bend in the shape of a hook which is attached to the superior part of said mast, allowing the device to hang from said hoop, without disabling it, so that it can continue to be used to sustain the user's beverage.

In a preferred embodiment, the fastening means of the container of popcorn are formed by a kind of clamp with two arcuate and swinging arms, which tend to press against the outer contour of the container placed on the base, thus adapting to different widths, relying for this purpose on a spring which tends to keep said arms in the closed position described, and therefore presses on the container of popcorn immobilizing it.

In a second embodiment, the mast has a vertically displaceable telescopic arm, being defined in said mast a notched channel for immobilizing of the arm in different positions, the same ending in a sort of inverted hook to fit the upper edge of the container regardless of its height, and so hold it firmly.

In this way, a support is achieved that adapts perfectly for containers of different heights and different widths, as well as configurations of design.

The device can be embodied in very diverse materials without affecting the essence of the invention, such as PVC, Teflon, nylon or any other material, with the special particularity that the bottom support platform remain fixed horizontally, or be foldable and hinged on the mast itself, thus occupying a minimum volume when not in use.

### DESCRIPTION OF THE DRAWINGS

To complement the description that is going to be made and to assist in a better understanding of the invention's characteristics, according to a preferred practical embodiment thereof, accompanying as an integral part of said description, are a set of drawings that are illustrative and not limitative in nature, which show the following:

FIG. 1 shows a representation corresponding to a perspective view of a support made according to the object of the present invention, in which the means of adaptation to the outer contours of the popcorn container are embodied in a clamp with two arched arms swinging against the tension of a spring.

FIG. 2 shows a lateral elevation view of the support of the previous figure.

FIG. 3 shows a top plan view of the support assembly of the previous figure.

FIG. 4 shows a front elevational view of the support assembly of FIG. 3.

FIG. 5 shows a perspective view of the support in a second variant of embodiment.

FIG. 6 shows a lateral elevation view of the support of FIG. 5 attached to the respective conventional support hoop for the beverage cup at the end of the armrest of a seat in a theater.

FIG. 7 shows a side view of the practical application of the support shown in the previous figure.

### PREFERRED EMBODIMENT OF THE INVENTION

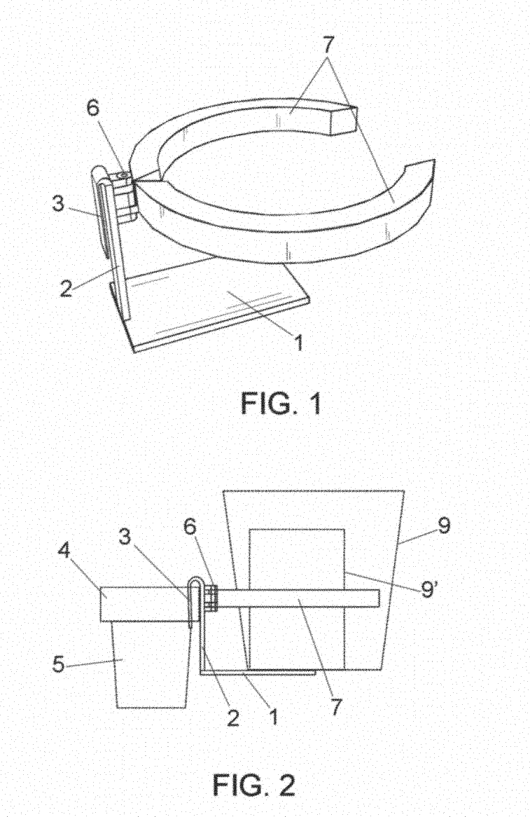

As can be seen in the mentioned figures and in connection specifically with FIGS. 1 to 4, the support of the invention is constituted from a horizontal platform (1) from one of whose edges rises a mast (2) topped with a hooking element (3) provided for hanging from the respective conventional hoop (4) at the end of the armrests of cinema chairs and the like, designed to receive a cup (5) or bottle with any type of drink.

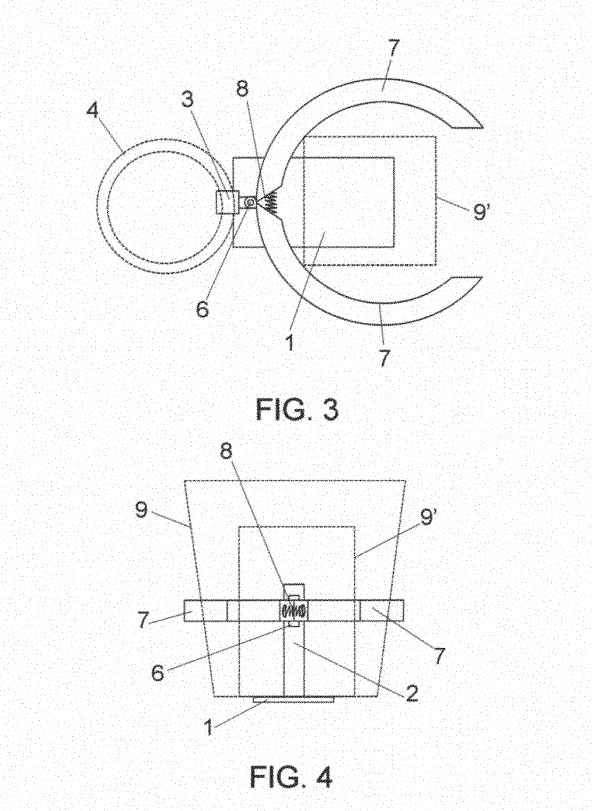

The mast (2) ends at the top and outwardly in a shaft (6) onto which are hinged a pair of arcuate arms (7) forming a clamp which tends to close by a spring (8) and thus fit a larger or smaller contour of a circular container of popcorn (9) or a container of quadrangular contour (9′), as shown in FIG. 3, where the platform (1) constitutes the support for the container's base (9-9′), while the arms (7) of the clip embrace the contour of said package stabilizing it, leaving the bracket attached to said hoop (4) of the seat or chair.

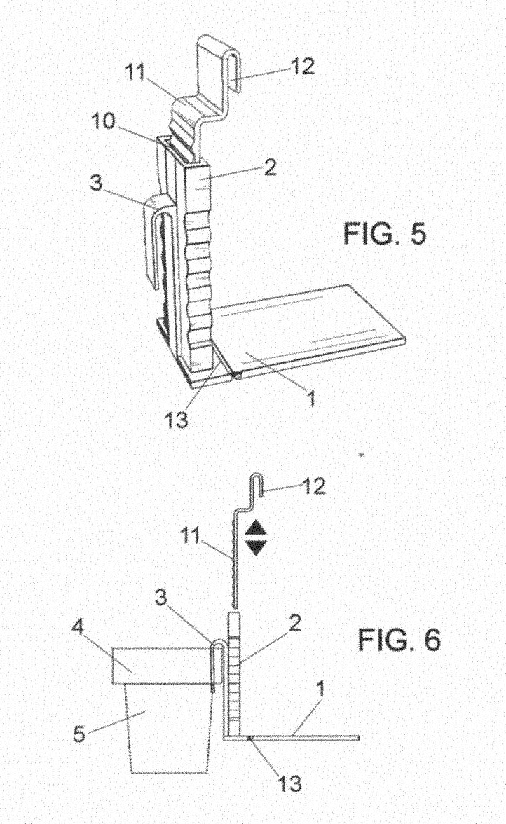

In an alternative embodiment, shown in FIGS. 5 to 7, the mast (2) has a notched upright groove (10) on which is a slidable arm (11), also notched and ending at the top in an inverted hook (12) whose function will be explained later.

The mast (2), as in the previous case, has a hooking element (3) for fastening the support assembly to the hoop (4) of the armrest of the seat intended for holding the corresponding beverage glass (5).

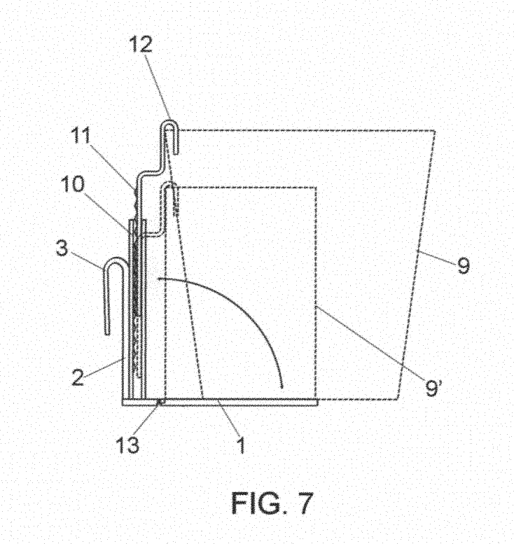

From this structure, the arm (11) is movable up and down and through its notches in different positions can be stably locked, so that the inverted hook (12) engages the upper edge of the container (9-9′) as shown in FIG. 7, stabilizing said container regardless of its design configuration.

Both in the embodiment of FIGS. 5 to 7 as in the embodiment of FIGS. 1 to 5, the platform (1) is susceptible of being hinged to the mast (2), to be able to fold and be folded over it, seeing reduced the volume of the support assembly when not in use.

Looking at FIGS. 5, 6 and 7, as the platform (1) is linked through a joint (13) at the same mast (2), joint that can be of any kind.

1. A support for holding a popcorn container having a predetermined width and the like, comprising:
a support platform for supporting a base of a container;
a vertical mast operatively connected to said support platform, said vertical mast comprising a hooking element at an upper portion thereof for engaging with an armrest of a theater seat; and
means operatively connected to said vertical mast for securing said container of popcorn thereto.

2. The support for holding a popcorn container and the like, according to claim 1, wherein said means for securing said container of popcorn comprises two swinging and arcuate arms biased to closure by a bias spring for adapting said two arms to a width of said container of popcorn.

3. The support for holding a popcorn container and the like, according to claim 1, wherein said means for securing said container of popcorn comprises a telescoping arm operatively connected to said vertical mast, said telescoping arm comprising an inverted hook at an upper portion thereof and adapted to restrain an upper edge of said container of popcorn.

4. The support for holding a popcorn container and the like, according to claim 1, wherein said support platform is foldable with respect to said vertical mast.
